(19) United States
(12) Patent Application Publication
(10) Pub. No.: US 2019/0147747 A1
(43) Pub. Date: May 16, 2019

(54) Remote Control of an Unmanned Aerial Vehicle

(71) Applicant: Telefonaktiebolaget LM Ericsson (publ), Stockholm (SE)

(72) Inventors: Tommy ARNGREN, SÖDRA SUNDERBYN (SE); Håkan BENNETT ERIKSSON, Brighton (AU)

(21) Appl. No.: 16/300,203

(22) PCT Filed: May 11, 2016
(86) PCT No.: PCT/SE16/50424

§ 371 Date: Nov. 9, 2018

(51) Int. Cl. G08G 5/00; H04W 4/029; G08G 5/02

(52) U.S. Cl. CPC G08G 5/006; G08G 5/0069; H04W 84/12; G08G 5/02; H04W 4/029

(57) ABSTRACT

It is presented a method for remote control of an unmanned aerial vehicle, UAV, (1). The method is performed by a wireless terminal (2) and comprises the steps of: determining obtaining (60) a geographical position and an identity of the UAV; retrieving (61) dynamic restriction data for the UAV based on the determined obtained geographical position and identity; and remotely (62) controlling the UAV based on the retrieved dynamic restriction data. It is also presented a wireless device, a computer program and a computer program product.

### TECHNICAL FIELD

The invention relates to a method for remote control of an unmanned aerial vehicle, and a wireless device, a computer program and a computer program product thereof.

### BACKGROUND

There are different examples of unmanned autonomous, semi-autonomous or remote operated vehicles. When it comes to flying unmanned vehicles, like UAVs (Unmanned Aerial Vehicles), there are two major categories. One category includes UAVs that fly beyond the visual line of sight, like Google's Project Wing and Amazon's Prime Air. Another category includes UAVs that are operated remotely and within line of sight, like Phantom Dji, Parrot AR Drone, etc.

The popularity of consumer UAVs is growing rapidly. According to ZDNet, Phontom Dji is selling about 30000 UAVs per month. The UAVs can be used for high-profile business cases—such as the Amazon retail delivery drones, Coke refresh delivery drones or the Domino's pizza delivery drones—but there are also everyday use cases that extend from filmmaking and aerial photography to fields such as real estate, farming and pipeline maintenance. Journalists want to work with them, as do meteorologists. Also, consumers may use UAVs to take amazing vacation pictures, or sneak-peeking into neighbours' pool areas, etc.

There are legal regulations and systems related to the control of national airspace, flight control systems or air traffic management systems.

There is work ongoing to solve the issue of handling thousands of new aircrafts in the national airspace. One example is the Pathfinder, an Unmanned Aerial System Traffic Management, called LATAS (Low Altitude Traffic and Airspace Safety system) provided by PrecisionHawk, Verizon et al that uses cellular network and satellite for airspace management. This is described in the article “An air traffic control system for drones?”, www.zdnet.com/article/an-air-traffic-control-system-for-drones/, retrieved on 18 Feb. 2016.

### SUMMARY

It is an object of the invention to enable improved restriction control of an unmanned aerial vehicle or an improved feature control associated with the unmanned aerial vehicle.

According to a first aspect, a method for remote control of an unmanned aerial vehicle, UAV, is presented. The method is performed by a wireless terminal and comprises the steps of obtaining a geographical position and an identity of the UAV, retrieving dynamic restriction data for the UAV based on the obtained geographical position and identity, and remotely controlling the UAV based on the retrieved dynamic restriction data.

By the presented method, it is possible to restrict the use of remotely controlled UAVs that lack other control means such as ATC (Air Traffic Control) transponders.

The geographical position of the UAV may indirectly be obtained by determining a geographical position of the wireless terminal.

The UAV may remotely be controlled via a peer-to-peer connection. The wireless terminal may be in connectivity with the UAV via a wireless local area network.

A UAV type may be determined by the identity of the UAV, and the dynamic restriction data may be based on the UAV type.

The retrieved dynamic restriction data may comprise one or more of the following: a limited range of operation, a sensor restriction, a landing instruction, and a hover instruction.

The UAV may be controlled to generate a sound and/or a light based on the retrieved dynamic restriction data.

The dynamic restriction data may be associated with a moving object.

The restriction data may comprise one or more of the following: UAV type, weight, camera, camera usage, seize, flight time, speed, communication capabilities, sensor capabilities, UAV functions, geographical position, and low altitude airspace restrictions.

According to a second aspect, a wireless terminal for remote control of an unmanned aerial vehicle, UAV, is presented. The wireless terminal comprises a processor and a computer program product. The computer program product stores instruction that, when executed by the processor, causes the wireless terminal to obtain a geographical position and an identity of the UAV, to retrieve dynamic restriction data for the UAV based on the obtained geographical position and identity, and to remote control the UAV based on the retrieved dynamic restriction data.

By the presented wireless terminal, it is possible to restrict the use of remotely controlled UAVs (including some of their features) that lack other control means such as ATC transponders.

According to a third aspect, a wireless terminal for remote control of an unmanned aerial vehicle, UAV, is presented. The wireless terminal comprises a determination manager for obtaining a geographical position and an identity of the UAV, and a communication manager for retrieving dynamic restriction data for the UAV based on the obtained geographical position and identity, and for remotely controlling the UAV based on the retrieved dynamic restriction data.

According to a fourth aspect, a computer program for remote control of an unmanned aerial vehicle, UAV, is presented. The computer program comprises computer program code which, when run on a wireless terminal, causes the wireless terminal to, obtain a geographical position and an identity of the UAV, to retrieve dynamic restriction data for the UAV based on the obtained geographical position and identity, and to remote control the UAV based on the retrieved dynamic restriction data.

According to a fifth aspect, a computer program product comprising a computer program and a computer readable storage means on which the computer program is stored, is presented.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating an environment where embodiments presented herein can be applied;

FIG. 2 is a schematic diagram illustrating an embodiment presented herein;

FIGS. 3-4 are schematic diagrams illustrating a moving object in two different positions according to an embodiment presented herein;

FIG. 5 is a schematic diagram illustrating some components of a wireless device;

FIGS. 6 is a flow chart illustrating a method for embodiments presented herein; and

FIG. 7 is a schematic diagram showing functional modules of a wireless device.

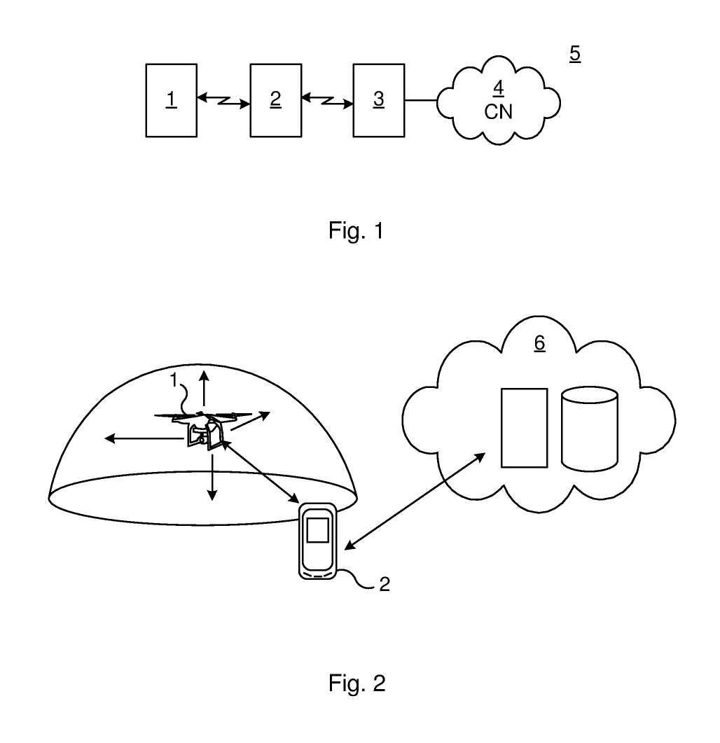

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

Existing solutions for air traffic control are not able to keep track of UAVs (Unmanned Aerial Vehicles) that lack ATC (Air traffic control) transponders or lack cellular connectivity. The existing UTM (Unmanned Aerial System Traffic Management) solutions do not handle moving and temporary low altitude airspace restrictions.

It would thus be advantageous to be able to enable flight control of UAVs that lack ATC transponders and therefore are not possible to track within national or regional airspace.

UAVs lacking cellular connectivity commonly use a peer-to-peer WLAN (Wireless Local Area Network) connection between the remote control, being a wireless terminal such as a smartphone or tablet PC, and the UAV for control of the UAV. The remote control can also be used for control of e.g. a camera, such as a video camera, of the UAV. In these cases, it is possible to have indirect positioning of the UAV based on the position of the remote control combined with the maximum range of the UAV or by using distance and altitude data from the UAV. If a mobile application in the wireless terminal, used to remotely control the UAV, gets flight restriction data from a central server, then it is possible to keep the UAV away from e.g. restricted airspace by alerts in the mobile application or by automatic control commands to the UAV, e.g. to automatically return to origin if too close to restricted airspace.

The presented solution above will make it possible for the remote control (i.e. a mobile application in a wireless terminal) to receive real time data about restrictions in available airspace. The restrictions may also include 3D geo-fences that are associated with approaching cars or persons, which will dynamically impact the available airspace for the UAV.

Further, it will be possible to restrict both the available airspace and the operation of the UAV, e.g. turn off the camera view/recording of the UAV if a 3D geo-fence is in range of the camera.

The presented solution will make it possible to keep track of UAVs without direct cellular connectivity or ATC transponders. The presented solution also makes it possible to dynamically add restrictions, such as 3D geo-fences, to the available airspace for the UAV. The presented solution further makes it possible to add restrictions to the operation, such as video/photo, of the UAV based on information about the available airspace. The presented solution thus enables tracking, flight restriction and operation restriction based on indirect positioning of UAVs.

The presented solution utilizes the following basic components, see FIG. 2.

A UAV 1, having a flight operation space illustrated with a hemisphere. The flight operation of the UAV 1 is illustrated with four arrows in a coordinate system (x, y, z).

A wireless device 2 for remote control of the UAV 1 is also disclosed. A client application in the wireless device 2 is used for the remote control of the UAV, e.g. using a peer-to-peer Wireless Local Area Network (WLAN) connection, such as WiFi. The client application may e.g. be an Android or iOS type of mobile app connected to a central server 6. The UAV 1 may have better cellular coverage then the wireless device 2, since it usually is higher up then the wireless device 2. In case the UAV 1 has cellular capability, e.g. wife, cellular connectivity or a proprietary link may be used between the UAV 1 and the wireless device 2, to relay connection to the central server 6 via the UAV 1. In other cases the UAV 1 may be down in a basement searching for a bomb, and the user (pilot) is standing on the street with cellular coverage, while the UAV 1 has not. In this case the signalling goes via the wireless device 2. However, it may still be e.g. wife, cellular connectivity or a proprietary link down to the UAV 1.

A central server 6 for control of UAVs and support to wireless devices 2 and their UAVs 1 is also disclosed. The central server may be one physical server host, but may also be a server farm or a virtual server distributed over a plurality of hosts.

Communications between the central server 6 and the wireless device 2 may be done using Hypertext Transfer Protocol (http) or similar protocols and communications between the wireless device 2 and the UAV 1 may use http or any proprietary protocol used for remote control of a UAV.

The central server 6 will interact with the client application to provide relevant flight restriction data for the UAV 1. The relevant flight restriction data is an example of dynamic restriction data within the meaning of this application, meant to be restriction data continuously or at intervals sent to the wireless device 2 during operation of the UAV 1, or initially before operation of the UAV 1. The dynamic restriction data may e.g. be required to be retrieved from the central server 6 before take-off for the UAV 1 is possible. The dynamic restriction data is not limited to position or flight space, but one of or a combination of speed of the UAV1, noise level of the UAV1 (e.g. with respect to what time it is), camera on/off, camera recording on/off, just for navigation (such as preferred route based on a parameter such as good telecommunications bandwidth), carrying load, what type of load etc. Other examples of dynamic flight restriction data are mentioned further down.

The central server 6 receives geographical position data and UAV 1 data from the wireless device 2. Based on the geographical position of the wireless device 2 and the UAV data the central server 6 provides relevant restrictions to the wireless device 2. When the central server 6 has knowledge of maximum flight operation space of the UAV 2, it may provide restrictions only within that maximum flight operation space. The remote control client application will adapt to received restriction data, such as adapt the flight operation space to the received restriction data, reduce the available flight operation space or change the operation of the UVA (e.g. turn of a camera), prevent the UAV to take off, and invoke the UAV to automatically return to the origin.

The central server 6 receives indirect UAV flight data via the client application. The client application is used for remote control of the UAV 1 using e.g. peer-to-peer WLAN communication. During remote control of a flying UAV 1, the client application may provide the following data to the central server 6: wireless device 2 position, distance to the UAV 1 and the altitude of the UAV 1. If the UAV 1 is equipped with a satellite-based positioning tracker, e.g. for GPS (Global Positioning System), UAV GPS data may be provided to the central server 6 from the client application. By receiving positioning data for the UAV 1, the central server 6 is then able to track a certain UAV 1, through direct or indirect position data. Other satellite-based positioning trackers may of course also be present instead or in addition to the GPS tracker, e.g. a GLONASS, GALILEO and BEIDOU compatible tracker.

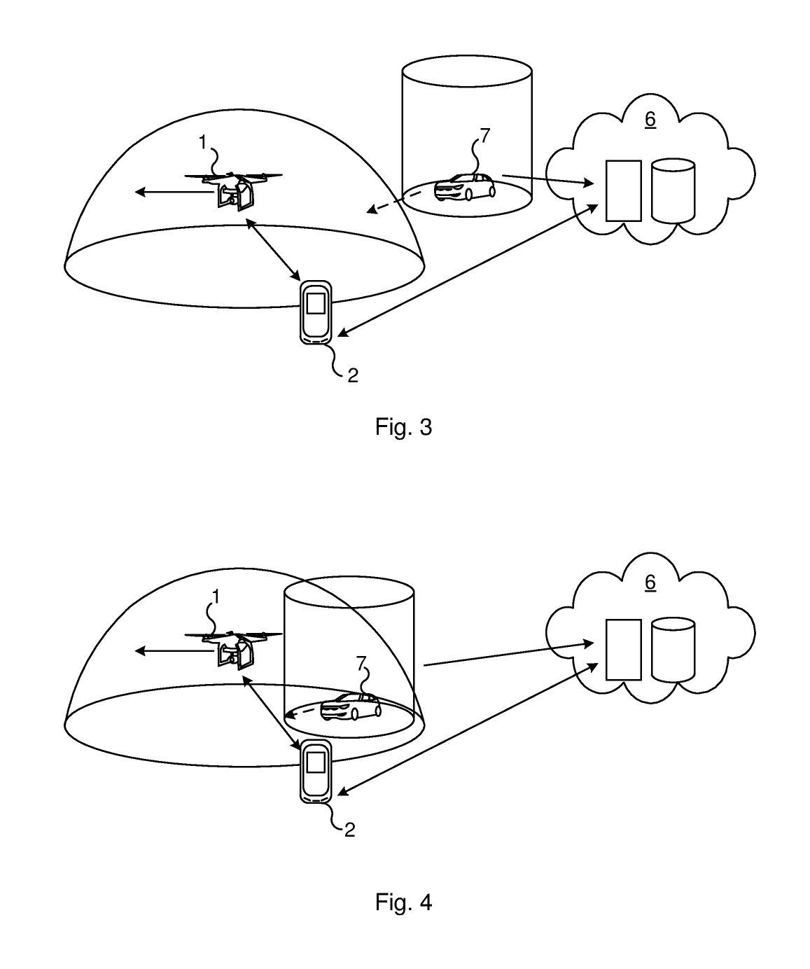

The central server 6 may get notified about a POI (Point of Interest) i.e. fixed objects such as airports or private properties, or moving objects such as a car or a person, in the proximity of a flying UAV 1, see FIG. 3.

A moving object 7, like a moving car, is approaching a flight operation space of a UAV 1, according to an example presented herein. Details about the moving object 7 are sent to the central server 6, e.g. through a cellular network, on a continuous basis (real time) or at regular intervals, which could be more frequent in proportion to the speed of the car and/or e.g. whether the engine of the car is on or not. The details about the car could also include data associated with the identity of the driver and/or passengers of the car. The central server 6 defines a 3D geo-fence (illustrated as a cylinder) for the moving object, which will add flight restrictions or other capability/feature restrictions (like camera function) to UAV 1 in case the 3D geo- fence of the car 7 interferes with the flight operation space of the UAV 1.

The central server 6 notifies the client application in the wireless terminal 2 about forthcoming changes in the flight restrictions based on the data about the moving object 7 sent in real-time or on regular intervals.

The client application may thus get continuous 3D geo-fence data from the central server 6 and adapts the UAV's flight operation space accordingly. In FIG. 4, it is illustrated that the 3D geo-fence of the car 7 interferes with the flight operation space of the UAV 1, see FIG. 3.

Restriction data retrieved by the wireless terminal 2 may comprise one or more of the following instructions: stop and hover, safe landing, return to origin following safe route, and turn off camera as the moving object 7 passes the flight operation space of the UAV 1.

The client application of the wireless terminal 2 may provide UAV flight status data to the central server 6, to enable the central server 6 to detect the UAV 1 as moving object for another user.

In an example, a user is taking a UAV to a suitable place for flying and photographing the surroundings from the sky. The user prepares the UAV and starts the client application, running on the wireless terminal, which is used for remote control of the UAV and a camera thereon.

As soon as the user starts the client application, the client application sends a geographical position and an identity of the UAV to the central server, which in return pushes flight restriction data, relevant to the position of the geographical position and identity of the UAV, to the client application.

The user is flying the UAV and takes some photos of the surroundings and its UAV flight data is continuously transmitted via the wireless terminal to the central server.

Suddenly there is a person walking with a dog in the same area and that person has a mobile phone connected to a UAV-free service. The mobile phone provides position and UAV-free data to the central server, which in turn is forwarded to the UAV client application. The UAV-free service may e.g. be a subscription service for users e.g. not wanting to be photographed or filmed, or not wanting to be near an UAV for risk of collision.

The UAV client application then adapts the flight space and operation to the received UAV-free data, a 3D geo-fence related to the person walking by with the dog. The size and extent of the geo-fence and/or operation may be associated with the subscription type of the UAV-free service. The president of the US may be required to have, for example, a much larger geo-fence and operation restriction requirements than what a typical average person might require. In this example the UAV stop, hover and turn off the camera while there is interference between the 3D geo-fence of the persons UAV-free data and the UAV flight operation space.

A central server providing a UAV-free service may comprise obtaining geographical position(s) and identity(ies) of one or more UAV, obtaining geographical position of a wireless terminal of a user subscribing to a UAV-free service, and sending restriction data to one or more UAV based on the geographical position of the wireless terminal and of the one or more UAV.

In an example, a farmer uses a UAV for checking animals. A static 3D geo-fence may be made up by the property boundary. The UAV may also be used to monitor the property for trespassing.

In another example, a UAV is used for monitoring sharks at a bathing area. A static 3D geo-fence for the beach may be combined with a dynamic 3D geo-fence for boats may be used.

A UAV may provide e.g. ID, type (provides maximum distance/altitude/speed (flight operation space further in relation wireless terminal)), activity and position to the wireless terminal for uploading to the central server. The central server may keep e.g. position, time, type, number, and activity for identification of possible interfering flight operation space and POI or moving object. A cached database may be used for static POIs, and a forced update of a cached database may be used upon a particular event or for moving objects.

UAV parameters may comprise the following: type; weight; camera yes/no, type, on/off, camera for navigation allowed, but not for registration, camera off over residential area, but on over target area; SIM; serial number (ID); seize; possible flight time (max); flight time remaining; maximum speed; wind resistance; microphone yes/no, type, on/off; speaker yes/no, type, on/off; weapons yes/no, type, on/off; load carrying capabilities; navigation lights yes/no, type, on/off; and spotlights yes/no, type, on/off.

User (pilot) parameters may comprise the following: certification; training; age; mission/reason to fly; distance from UAV, altitude of UAV; can see UAV; track record from earlier flights; considerate and friendly pilot as rated on e.g. Facebook; aggressive and unfriendly pilot as rated on e.g. Facebook; and single pilot or with a team.

Environment parameters may comprise the following: geographical position; time, dynamic geo-fence (i.e. a geo-fence which may vary in size and position), e.g. time dependent (time of day, daytime/night time and/or time of year); indoor/outdoor; weather (wind, rain, humidity, temperature); visibility (daylight, fog, smoke); other UAVs in the area (maximum); zoning (residential, industry, park, etc.); how much people are likely to be there; event ongoing; animals present; endangered species (fauna or flora); and activate/deactivate sound/light signal.

A method, according to an embodiment, for remote control of an unmanned aerial vehicle, UAV, is presented with reference to FIG. 6. The method is performed by a wireless terminal 2 and comprises the steps of obtaining 60 a geographical position and an identity of the UAV 1, retrieving 61 dynamic restriction data for the UAV based on the obtained geographical position and identity, and remotely 62 controlling the UAV based on the retrieved dynamic restriction data.

The geographical position of the UAV may indirectly be obtained based on by determining a geographical position of the wireless terminal.

The UAV may remotely be controlled via a peer-to-peer connection. The wireless terminal may be in connectivity with the UAV via a Wireless Local Area Network.

A UAV type may be determined by the identity of the UAV, and the dynamic restriction data is then based on the UAV type.

The retrieved dynamic restriction data may comprise one or more of the following: a limited range of operation, a sensor restriction, a landing instruction, and a hover instruction.

The UAV may be controlled to generate a sound and/or a light based on the retrieved dynamic restriction data.

The dynamic restriction data may be associated with a moving object.

The dynamic restriction data may comprise one or more of the following: UAV type, weight, camera, camera usage, seize, flight time, speed, communication capabilities, sensor capabilities, UAV functions, geographical position, and low altitude airspace restrictions.

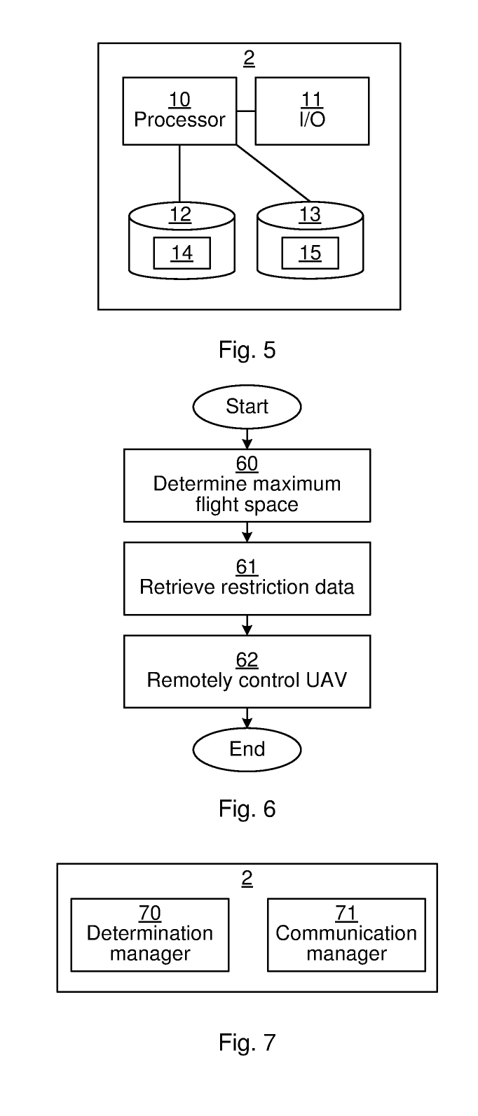

A wireless terminal 2, according to an embodiment, for remote control of an UAV 1, is presented with reference to FIG. 5. The wireless terminal 2 comprises a processor 10 and a computer program product 12, 13. The computer program product 12, 12 stores instructions that, when executed by the processor, causes the wireless terminal to: obtain 60 a geographical position and an identity of the UAV, retrieve 61 dynamic restriction data for the UAV based on the obtained geographical position and identity, and remote 62 control the UAV based on the retrieved dynamic restriction data.

A wireless terminal 2, according to an embodiment, for remote control of an UAV 1, is presented with reference to FIG. 7. The wireless terminal 2 comprises: a determination manager 70 for obtaining 60 a geographical position and an identity of the UAV, and a communication manager 71 for retrieving 61 dynamic restriction data for the UAV based on the obtained geographical position and identity, and for remotely 62 controlling the UAV based on the retrieved dynamic restriction data.

A computer program 14, 15, according to an embodiment, for remote control of an UAV 1, is presented with reference to FIG. 5. The computer program comprises computer program code which, when run on a wireless terminal 2, causes the wireless terminal to obtain 60 a geographical position and an identity of the UAV, retrieve 61 dynamic restriction data for the UAV based on the obtained geographical position and identity, and remote 62 control of the UAV based on the retrieved dynamic restriction data.

A computer program product 12, 13, according to an embodiment presented herein, comprises a computer program 14, 15 and a computer readable storage means on which the computer program 14, 15 is stored.

FIG. 5 is a schematic diagram showing some components of the wireless terminal 2. A processor 10 may be provided using any combination of one or more of a suitable central processing unit, CPU, multiprocessor, microcontroller, digital signal processor, DSP, application specific integrated circuit etc., capable of executing software instructions of a computer program 14 stored in a memory. The memory can thus be considered to be or form part of the computer program product 12. The processor 10 may be configured to execute methods described herein with reference to FIG. 6.

The memory may be any combination of read and write memory, RAM, and read only memory, ROM. The memory may also comprise persistent storage, which, for example, can be any single one or combination of magnetic memory, optical memory, solid state memory or even remotely mounted memory.

A second computer program product 13 in the form of a data memory may also be provided, e.g. for reading and/or storing data during execution of software instructions in the processor 10. The data memory can be any combination of read and write memory, RAM, and read only memory, ROM, and may also comprise persistent storage, which, for example, can be any single one or combination of magnetic memory, optical memory, solid state memory or even remotely mounted memory. The data memory may e.g. hold other software instructions 15, to improve functionality for the wireless terminal 2.

The wireless terminal 2 may further comprise an input/output, I/O, interface 11 including e.g. a user interface. The wireless terminal may further comprise a receiver configured to receive signalling from other nodes, and a transmitter configured to transmit signalling to other nodes (not illustrated). Other components of the network node or stationary wireless device are omitted in order not to obscure the concepts presented herein.

FIG. 7 is a schematic diagram showing functional blocks of the wireless terminal 2. The modules may be implemented as only software instructions such as a computer program executing in the cache server or only hardware, such as application specific integrated circuits, field programmable gate arrays, discrete logical components, transceivers, etc. or as a combination thereof. In an alternative embodiment, some of the functional blocks may be implemented by software and other by hardware. The modules correspond to the steps in the methods illustrated in FIG. 6, comprising a determination manager unit 70 and a communication manager unit 71. In the embodiments where one or more of the modules are implemented by a computer program, it shall be understood that these modules do not necessarily correspond to process modules, but can be written as instructions according to a programming language in which they would be implemented, since some programming languages do not typically contain process modules.

The determination manager 70 is for determining position and identity for an UAV. This module corresponds to the obtain step 60 of FIG. 6. This module can e.g. be implemented by the processor 10 of FIG. 5, when running the computer program.

The communication manger 71 is for controlling wireless communication with communication network and with the UAV. This module corresponds to the receive step 61 and the remote control step 62 of FIG. 6. This module can e.g. be implemented by the processor 10 of FIG. 5, when running the computer program.

The invention has mainly been described above with reference to a few embodiments. However, as is readily appreciated by a person skilled in the art, other embodiments than the ones disclosed above are equally possible within the scope of the invention, as defined by the appended patent claims.

1. A method for remote control of an unmanned aerial vehicle, UAV, the method being performed by a wireless terminal and comprising the steps of
obtaining a geographical position and an identity of the UAV;
retrieving dynamic restriction data for the UAV based on the obtained geographical position and identity; and
remotely controlling the UAV based on the retrieved dynamic restriction data.

2. The method according to claim 1, wherein the geographical position of the UAV is indirectly obtained by determining a geographical position of the wireless terminal.

3. The method according to claim 1, wherein the UAV is remotely controlled via a peer-to-peer connector.

4. The method according to claim 3, wherein the wireless terminal is in connectivity with the UAV via a Wireless Local Area Network.

5. The method according to claim 1, wherein a UAV type is determined by the identity of the UAV, and the dynamic restriction data is based on the UAV type.

6. The method according to claim 1, wherein the retrieved dynamic restriction data comprises one or more of the following: a limited range of operation, a sensor restriction, a landing instruction, and a hover instruction.

7. The method according to claim 1, wherein the UAV is controlled to generate a sound and/or a light based on the retrieved dynamic restriction data.

8. (canceled)

9. The method according to claim 1, wherein the restriction data comprises one or more of the following: UAV type, weight, camera, camera usage, seize, flight time, speed, communication capabilities, sensor capabilities, UAV functions, geographical position, and low altitude airspace restrictions.

10. A wireless terminal for remote control of an unmanned aerial vehicle, UAV, the wireless terminal comprising:
a processor; and
a computer program product storing instruction that, when executed by the processor, causes the wireless terminal to:
obtain a geographical position and an identity of the UAV;
retrieve dynamic restriction data for the UAV based on the obtained geographical position and identity; and
remote control the UAV based on the retrieved dynamic restriction data.

11. The wireless terminal according to claim 10, wherein the geographical position of the UAV is indirectly obtained by determination of a nographical position of the wireless terminal.

12. The wireless terminal according to claim 10, wherein the UAV is remotely controlled via a peer-to-peer connection.

13. The wireless terminal according to claim 12, wherein the wireless terminal is in connectivity with the UAV via a Wireless Local Area Network.

14. The wireless terminal according to claim 10 wherein a UAV type is determined by the identity of the UAV, and the dynamic restriction data is based on the UAV type.

15. The wireless terminal according to claim 10, wherein the retrieved dynamic restriction data comprises one or more of the following: a limited range of operation, a sensor restriction, a landing instruction, and a hover instruction.

16. The wireless terminal according to claim 10, wherein the UAV is controlled to generate a sound and/or a light based on the retrieved dynamic restriction data.

17. (canceled)

18. The wireless terminal according to claim 10, wherein the restriction data comprises one or more of the following: UAV type, weight, camera, camera usage, seize, flight time, speed, communication capabilities, sensor capabilities, UAV functions, geographical position, and low altitude airspace restrictions.

19. (canceled)

20. A computer program product for remote control of an unmanned aerial vehicle, UAV, said computer program product comprising a computer program and a computer readable storage means on which the computer program is stored said computer program comprising computer program code which, when run on a wireless terminal, causes the wireless terminal to:
obtain a geographical position and an identity of the UAV;
retrieve dynamic restriction data for the UAV based on the obtained geographical position the identity and associated with a moving object; and
remote comtrol of the UAV based on the retrieved dynamic restriction data.

21. (canceled)
